(19) United States
(12) Patent Application Publication
(10) Pub. No.: US 2025/0246847 A1
(43) Pub. Date: Jul. 31, 2025

(54) WATERPROOF RETENTION LOCKING MECHANISM FOR CITIZEN'S BAND RADIO DEVICE

(71) Applicant: Cedar Electronics Holdings Corp., Rolling Meadows, IL (US)

(72) Inventors: Chris deWaal, Oakwood Hills, IL (US); Carey Romano, Cary, IL (US)

(21) Appl. No.: 19/036,848

(22) Filed: Jan. 24, 2025

Related U.S. Application Data
(60) Provisional application No. 63/625,410, filed on Jan. 26, 2024.

(51) Int. Cl. H01R 13/52; H01R 13/625

(52) U.S. Cl. CPC H01R 13/5219; H01R 13/625; H01R 2201/24

(57) ABSTRACT

This disclosure is a locking mechanism system that provides for a watertight seal that is capable of retaining connection when exposed to external forces. The system comprises a connecting assembly, having a connector body, a collar, a seal, and a connector plug. The collar, may be positioned around the connector body and includes a rotation portion, an engagement portion, and a plurality of flanges, wherein the collar is configured to at least partially rotate around the connector body. The seal is coupled to the connector body, and the connector plug is coupled to the seal. The receiving assembly may include an input device receptacle, which includes retention flanges, a gasket, and a receiving receptacle. In response to rotation of the collar, the retention flanges interlock with the collar's flanges and the engagement portion is cinched into the input device receptacle to form a lasting, waterproof connection.

### CROSS-REFERENCE TO RELATED APPLICATION

The application claims priority to U.S. Provisional Patent Application No. 63/625,410, filed on Jan. 26, 2024, entitled “WATERPROOF RETENTION LOCKING MECHANISM FOR CITIZEN'S BAND RADIO DEVICE,” the disclosure of which is incorporated herein by reference in its entirety.

### BACKGROUND

Citizen's band (CB) radio devices are used in a variety of applications to enable short-distance, one-to-many bidirectional voice communication. Generally, a handset, including a corded speaker and a microphone, is plugged into the CB radio device to allow a user to communicate with others using radio devices operating at a CB frequency. In a variety of these applications, the handset and the CB radio device may experience exposure to different forces which that threaten the physical connection between them, such as a user pulling on the cord of the handset or exposure to water.

### SUMMARY

The present disclosure provides for a locking mechanism that creates a tight, waterproof connection between a connecting assembly and a receiving assembly. The locking mechanism prevents exposure to water and other materials that may interrupt the connection or damage the components of the connecting assembly, e.g. a CB radio handset, and a receiving assembly, e.g. a CB radio device.

A locking mechanism system comprises a connecting assembly and a receiving assembly. The connecting assembly may include a connector body, which is generally cylindrical about a central axis and extends along a first length from a first surface to a second surface. The connector body also may include an interior cavity which extends through the connector body along the first length from the first surface of the connector body to the second surface of the connector body to form a first opening and a second opening. The connecting assembly may also include a collar, which is generally cylindrical about the central axis and extends along a second length from a first edge to a second edge. The collar may be positioned around the connector body. The collar may also include a rotation portion, having a first radius, and an engagement portion, the engagement portion having a second radius. The first radius is longer than the second radius. The engagement portion may include a plurality of flanges disposed around the first edge, the flanges protruding away from the central axis. The collar is configured to at least partially rotate around the connector body.

The connecting assembly may further include a seal coupled to the connector body and abutting the first surface. The seal may also include a third opening which at least partially aligns with the first opening. The seal may have a radius larger radius than the second radius. The connecting assembly may also include a connector plug, having an isotropic shape and coupled to the seal. The connector plug may also include wiring which extends through the third opening of the seal, the first opening of the connector body, the interior cavity of the connector body and out from the second opening of the connector body.

The system may also include a receiving assembly. The receiving assembly may include an input device receptacle, which is generally cylindrical about the central axis and extends along a third length from a third edge to a third surface. The input device receptacle includes a plurality of retention flanges disposed around the third edge and protruding toward the central axis. The input device receptacle may be configured to receive the connector plug, seal, and engagement portion. The receiving assembly may also include a gasket disposed over the fourth surface configured to abut the seal. The receiving assembly may also include a receiving receptacle coupled to the fourth surface and configured to receive the connector plug. The receiving assembly may be configured such that in response to a rotation of the collar, the retention flanges interlock with the flanges of the collar and the engagement portion is cinched into the input device receptacle to form a waterproof connection between the connecting assembly and the receiving assembly.

In an embodiment of the present disclosure, the receiving assembly includes a receiving assembly body housing the components of the receiving assembly and a connector affixing at least a portion of the receiving assembly body to a surface. The system may further include an extension assembly including an extension cable connecting to the connector plug and extending out from the connector plug body, out of an opening in the receiving assembly body, and to an extension connector plug, the extension connector plug including an extension plug gasket.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIGS. 1a and 1b illustrate example embodiments of locking mechanism systems according to an aspect of the present invention.

FIG. 2 illustrates an exploded view of the components of an example connecting assembly of the present invention.

FIG. 3 illustrates a perspective view of an example connecting assembly of the present invention.

FIG. 4 illustrates a profile cutout perspective view of an example receiving assembly of the present invention.

FIG. 5 illustrates an exploded view of the components of an example receiving assembly of the present invention.

FIG. 6 illustrates a profile cutout perspective of an example locking mechanism system of the present invention.

FIG. 7 illustrates a profile cutout perspective of an example locking mechanism system with an extension assembly of the present invention.

### DETAILED DESCRIPTION

The present disclosure provides a system for a new and innovative locking mechanism. The locking mechanism provides a watertight seal that is able to withstand external force to maintain a connection.

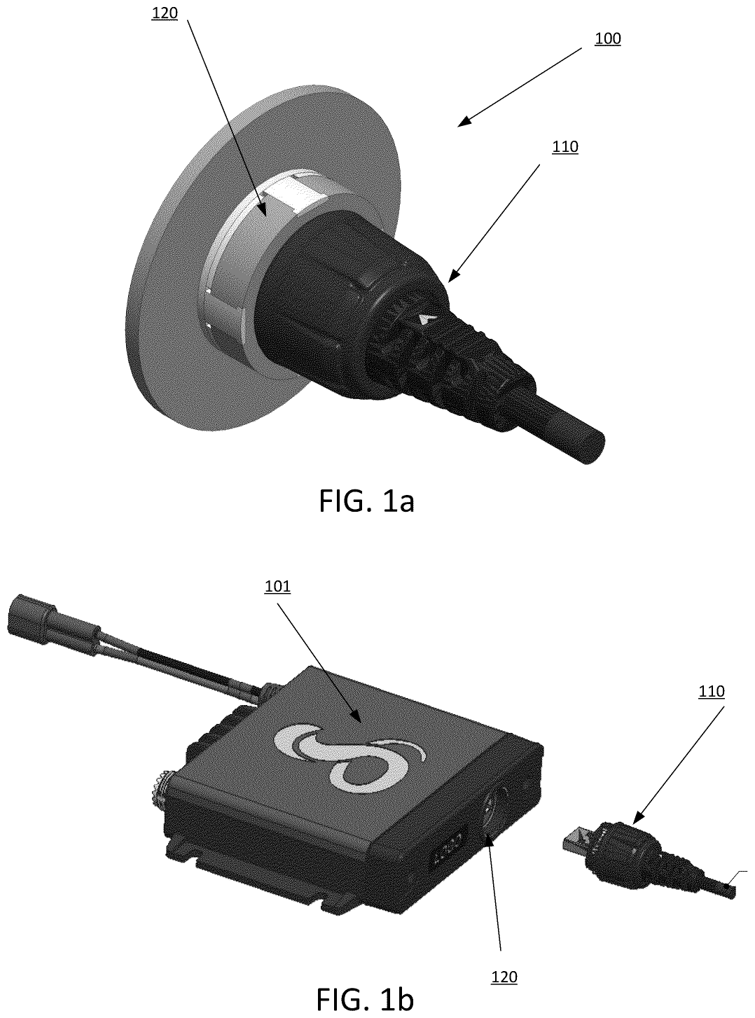

FIGS. 1a and 1b illustrate example embodiments of a locking mechanism system 100 of the present invention. The system 100 may include a connecting assembly 105 and a receiving assembly 130. The connecting assembly 105 may include a handset used for radio communication. As shown in FIG. 1b, at least a portion of the receiving assembly 130 may be installed in an electronic device 101, such as a CB radio configured for installation in a dashboard of a vehicle.

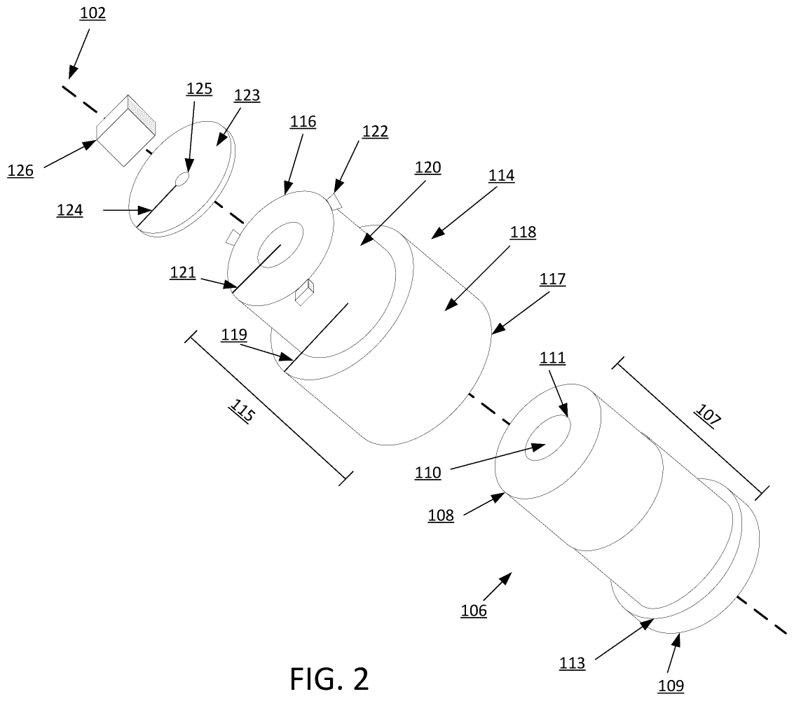

FIG. 2 illustrates an exploded view of the components of an example connecting assembly 105 of the present invention. The connecting assembly 105 may include a connector body 106, which is generally cylindrical about a central axis 102. The connector body 106 may extend along a first length 107 from a first surface 108 of the connector body 106 to a second surface 109 of the connector body 106. The connector body 106 may also include an interior cavity 110 such that the connector body 106 is substantially hollow. The interior cavity 110 may extend through the connector body 106 along the first length 107 from a first opening 111 and a second opening 112. The connector body 106 may also include a retention rim 113 configured to keep a collar 114, positioned around the connector body 106.

The connecting assembly 105 may also include a collar 114, which is generally cylindrical about the central axis 102. The collar 114 may extend along a second length 115 from a first edge 116 to a second edge 117. The collar 114 is positioned around the connector body 111 such that the collar 114 is configured to at least partially rotate around the connector body 111. The collar 114 may include a rotation portion 118 having a first radius 119 and an engagement portion 120 having a second radius 121. The first radius 119 is greater than the second radius 121.

The engagement portion 120 may include a plurality of flanges, e.g. flange 122. These flanges 122 may protrude away from the central axis 102. The engagement portion 120 may be configured to engage with components of the receiving assembly 130 such that a waterproof, tight connection is formed between the connecting assembly 105 and the receiving assembly 130.

The connecting assembly 105 may also include a seal 123 coupled to the connector body 106 which may abut the first surface 108. The seal 123 has a third radius 124 which is larger than the second radius 121. This prevents the collar 114 from advancing past the seal 123 along the central axis 102. The seal 123 and the retention rim 113 of the connector body 106 work to limit the movement of the collar 114 along the central axis 102 and hold the collar 114 in place around the connector body 106. The seal 123 may also include a third opening 125 which at least partially aligns with the first opening 111.

The connecting assembly 105 may also include a connector plug 126. The connector plug 126 may be coupled to the seal 123, preferably in the center of the seal 123, such that wiring 127 (not shown) may extend through the third opening 125, the first opening 111, the interior cavity 110 of the connector body 106 and out from the second opening 112. The connector plug 126 may include a universal serial bus USB connector, such as a USB-A, USB-C, mini-USB or micro-USB connector. The connector plug 26 may also be an RJ-45 or RJ-11 type connector plug. Additionally, the connector plug 126 may also be one of a 4-pin CB microphone connector, a 5-pin CB microphone connector, or a 6-pin CB microphone connector. Accordingly, the connector plug 126 may be any suitable connector, and the example connector types describes herein are not limiting. The wiring 127 may include any suitable transmission line, such as cabling or printed feedlines on a printed circuit board (not shown) in connection with the connector plug 126.

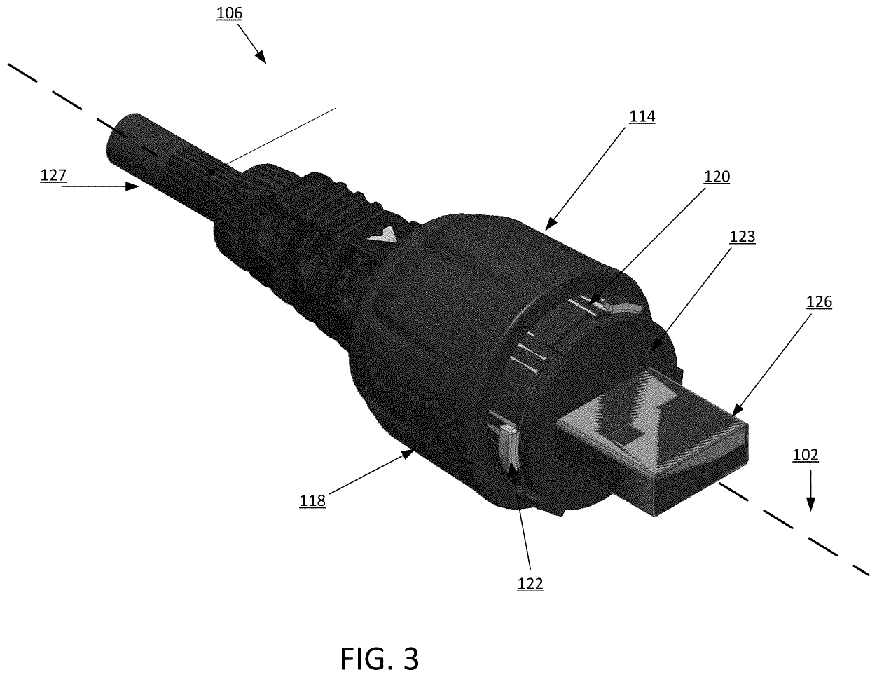

FIG. 3 illustrates a perspective view of an example connecting assembly 106 of the present invention. In this example, the connecting assembly is the plug end of a radio handset, having a type USB-A connector plug 126 and associated wiring 127. In response to a rotation of the rotation portion 118 of the collar 114, the seal 123 and attached connector plug 126 may be configured to remain stationary, i.e. not rotate about the central axis 102. The rotation of the collar 114 also results in the rotation of the engagement portion 120 and the plurality of flanges 122 disposed on the engagement portion 120.

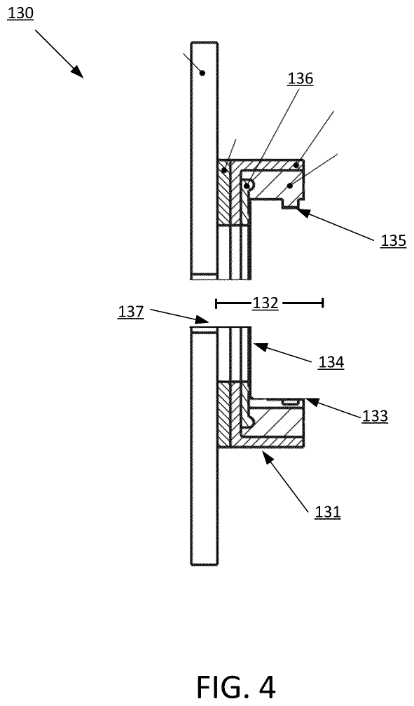

FIG. 4 illustrates a profile cutout perspective view of an example receiving assembly 130 of the present invention. The receiving assembly 130 may include an input device receptacle 131 which may be generally cylindrical about the central axis 102 (not shown). The input device receptacle 131 may extend along a third length 132 from a third surface 134 to a third edge 133. The input device receptacle 131 may be configured to receive a portion of the connecting assembly 105, such as the connector plug 126, the seal 123, and the engagement portion 120 of the collar 114.

The input device receptacle 131 may include a plurality of retention flanges 135 disposed around the third edge 133. The input device receptacle 131 may be substantially hollow, such that the retention flanges 135 may protrude inwards toward the central axis 102. Each of the retention flanges 135 may be positioned at or near the third edge 133. The retention flanges 135 may be longer in length than the plurality of flanges, e.g. flange 122, disposed on the engagement portion 120 of the collar 114. The retention flanges 135 may be configured to connect with the plurality of flanges 122 disposed on the engagement portion 120. For example, upon presentation of the connecting assembly 105 to the receiving assembly 130, at least a partial clockwise rotation of the rotation portion 118 of the collar 114 may cause the plurality of flanges 122 disposed on the engagement portion 120 of the collar 114 to connect with the retention flanges 135. This connection forms a water tight seal between the connecting assembly 105 and the receiving assembly 130.

This connection also maintains the necessary tension for the connector plug 126 (and any electrical device to which the connecting assembly is attached, e.g. electrical device 102) to continue functioning in the presence of forces acting on the connecting assembly. For example, a connecting assembly 105 may include a USB-A connector plug connected to a microphone handset for use in CB radio communications, and the receiving assembly 130 may include a CB radio device into which the handset is plugged located in an off-road recreational vehicle. The connection formed by the locking of the flanges 122 disposed on the collar of the connecting assembly 105 and the retention flanges 135 of the input device receptacle 131 in the outdoor recreational vehicle may withstand the force of a user pulling on the handset while in use while operating the vehicle off-road (e.g., if the CB radio cord is yanked upon hitting a large bump).

The retention flanges 135 may form a reverse-L shape including a portion of each retention flange 135 being configured to prevent the rotation of the collar 114 in a locking direction from progressing. This portion of each retention flange 135 may contribute to the maintaining of tension in the connection between the connecting assembly 105 and the receiving assembly 135.

The receiving assembly 130 may also include a gasket 136 disposed over the third surface 134, and the gasket 136 may abut the seal 123. For example, the gasket 136 may include a thin rubber component which is disposed over the third surface 134 to which the connecting assembly 105 may be subsequently presented.

The receiving assembly 130 may include a receiving receptacle 137 configured to receive the connector plug 126. For example, the receiving receptacle 137 may include a female-type USB-C connector configured for connection with a male-type USB-C connector plug. In additional examples, the receiving receptacle may be configured to receive a USB-A, USB-mini, USB-micro, RJ-45, RJ-11, 4-pin CB microphone, 5-pin CB microphone, or 6-pin CB microphone connector plug. The receiving receptacle 137 may be any suitable connector configured connector configured to receive the connector plug 126. The receiving receptacle 137 types described herein are not limiting.

In response to an at least partial rotation of the collar 114 in a locking direction, the retention flanges interlock with the flanges of the collar 114, which cinches the engagement portion 120 of the connecting assembly 105 into the input device receptacle 131 and up against the gasket 136, resulting in pressure that forms a tight, waterproof connection between the connecting assembly 105 and the receiving assembly 130 capable of withstanding the pulling, jerking, and other movement of the connecting assembly 105 or the electronic device 101 to which the connecting assembly is joined.

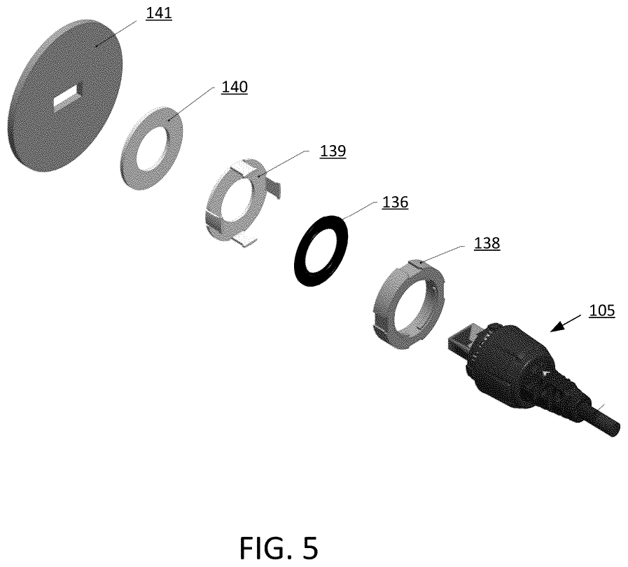

FIG. 5 illustrates an exploded view of the components of an example receiving assembly 110 of the present invention. The receiving assembly 130 may include an input device receptacle 131 comprising a top adapter 138 and a bottom adapter 139. The bottom adapter 139 may include snap-fit connectors to join the bottom adapter 139 to the top adapter 138 to form a generally cylindrical shape. The gasket 136 may disposed between the bottom adapter 139 and the top adapter 138 when the adapters are connected. The top adapter 138 may include the retention flanges 135 for connection to the flanges 122 disposed on the collar 114 of the connecting assembly 105. A ring of adhesive tape 140 may join the connected top adapter 138 and bottom adapter 139 with the gasket 136 disposed in between to a dashboard panel 141. The dashboard panel 141 may further be installed in an electronic device, such as a CB radio device mounted to the dashboard of a vehicle.

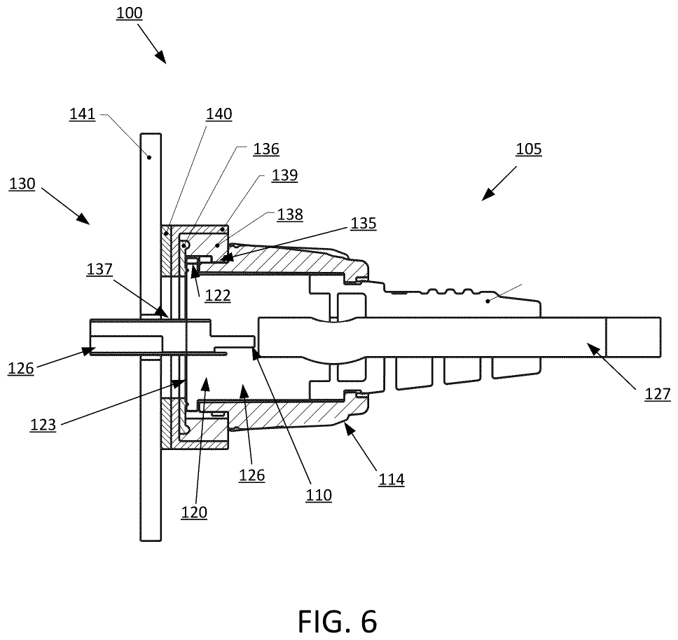

FIG. 6 illustrates a profile cutout perspective of an example locking mechanism system 100 of the present invention, specifically, an interconnected connecting assembly 105 and receiving assembly 130. Upon rotation of the rotation portion 118 of the collar 114, the plurality of flanges, e.g. flange 122, interlocks with the retention flanges 135 disposed on the input device receptacle 131, such as on the of the receiving assembly 130. This motion cinches the connector plug 126 into the receiving receptacle 137. For example, the rotation may result in the seal 123 abutting against the gasket 136, which may be a rubber component disposed between a connected top adapter 138 and bottom adapter 139. The pressure formed by this motion forcing the seal 123 up against the rubber gasket 136 helps to provide a water tight seal between the connecting assembly 105 and the receiving assembly 130.

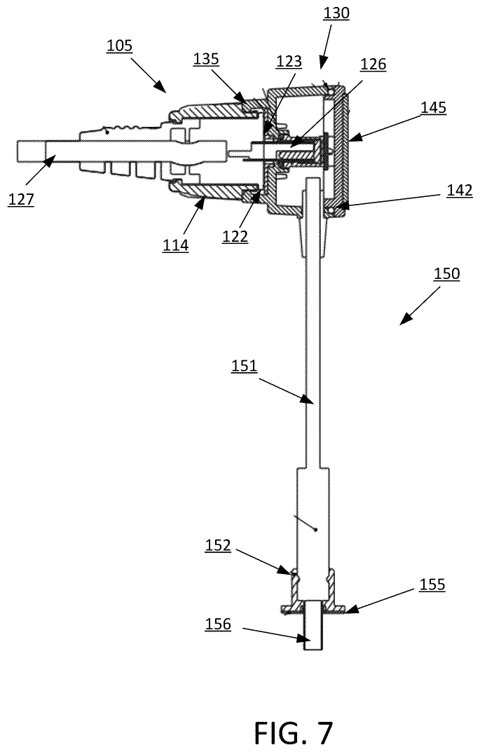

FIG. 7 illustrates a profile cutout perspective of another example embodiment of a locking mechanism system 100 of the present invention including an interconnected connecting assembly 105 and receiving assembly 130 as well as an extension assembly 150. The extension assembly 150 may be deployed, for example, in settings where the receptacle for an electronic device, such as the USB port of a CB radio device, is not positioned in a convenient location for a user to consistently insert the plug of a radio handset. In embodiments utilizing an extension assembly, e.g. extension assembly 150, the receiving assembly 130 may comprise a receiving assembly body 142 containing the components of the receiving assembly 130 and to be affixed to a surface in a more convenient location. For example, the receiving assembly 130 may be affixed to the dashboard of a vehicle via adhesive 145. In another example, the receiving assembly 130 may be outfitted with wings which allow for the receiving assembly to be affixed to a surface by screwing the receiving assembly 130 onto a surface (not shown). The manner in which the receiving assembly 130 is affixed to a surface allows for the locking mechanism to maintain its retention capabilities between the connecting assembly 105 and the receiving assembly 130, by ensuring that when the locking mechanism experiences various pulling and jerking forces the receiving assembly 130 maintains its connection with the connection assembly 105 and the receiving assembly 130 remains affixed to the surface.

The extension assembly 150 may include an extension cable 151, which extends from an opening in the receiving assembly body 142 to an extension connector plug 156 configured to be inserted into a compatible receptacle, e.g. a USB-A type receptacle of a CB radio device. The extension cable 151 may facilitate the transmission of the signals received at the connector plug 126 to extension connector plug 156 for outputting to an external electronic device (not shown). Additionally, connector plug 126 may vary in type from extension connector plug 156. For example, connector plug 126 may be a USB-C type plug and extension connector plug 156 may be a USB-A type plug, such that the extension assembly 150 may act as an adapter when receiving receptacle 137 is configured to be a different type of receptacle than the receptacle type of the external electronic device.

Extension cable 151 may include an extension plug gasket 152 which facilitates the retained connection of extension connector plug 156 to a receiving receptacle of an external electronic device (not shown). Plug gasket 152 may include adhesive 155 to affix the extension connector plug 156 to the receiving receptacle of an external electronic device and provide waterproofing in order to ensure that the connection between the locking mechanism and the external device is maintained.

The use of extension cable 151 and extension connector plug 156 with receiving assembly 130 allows for the use of the system in applications in which the connector body 106, collar 114, the seal 123, or another component of the connecting assembly 105 may block or prevent the connector plug 126 from properly engaging the receptacle of a CB radio device, for example because the diameter of the seal 123 is too large such that the connector assembly does not fit into the space in which the plug is intended to engage the receptacle. In other words, the plug side of a CB radio handset, although the correct connector type, is too large to be compatible with the CB radio device. Accordingly, the extension embodiment allows for use of the handset in such situations providing the user with a tight, lasting, and waterproof connection.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A system comprising:
a connecting assembly including:
a connector body, which is generally cylindrical about a central axis, extends along a first length from a first surface to a second surface, and includes an interior cavity, which extends through the connector body along the first length from the first surface of the connector body to the second surface of the connector body to form a first opening and a second opening,
a collar, which is generally cylindrical about the central axis, positioned around the connector body, extends along a second length from a first edge to a second edge, and includes a rotation portion, having a first radius, and an engagement portion, the engagement portion having a second radius, a plurality of flanges disposed around the first edge, the flanges protruding away from the central axis, wherein the collar is configured to at least partially rotate around the connector body, and the first radius is greater than the second radius,
a seal coupled to the connector body abutting the first surface, includes a third opening that at least partially aligns with the first opening, and has a radius larger than the second radius, and
a connector plug, having an isotropic shape, coupled to the seal and including wiring which extends through the third opening of the seal, the first opening of the connector body, the interior cavity of the connector body and out the second opening of the connector body; and
a receiving assembly including:
an input device receptacle, which is generally cylindrical about the central axis, extends along a third length from a third edge to a fourth surface, and has a plurality of retention flanges disposed around the third edge, the retention flanges protruding toward the central axis, wherein the input device receptacle is configured to receive the connector plug, seal, and engagement portion,
a gasket disposed over the fourth surface configured to abut the seal, and
a receiving receptacle coupled to the fourth surface configured to receive the connector plug, wherein the receiving assembly is configured such that in response to a rotation of the collar, the retention flanges interlock with the flanges of the collar and the engagement portion is cinched into the input device receptacle to form a waterproof connection between the connecting assembly and the receiving assembly.

2. The system of claim 1, wherein the receiving assembly further comprises a receiving assembly body housing the components of the receiving assembly and a connector affixing at least a portion of the receiving assembly body to a surface, and further comprising an extension assembly including:
an extension cable connecting to the connector plug and extending out from the connector plug body, out of an opening in the receiving assembly body, and to an extension connector plug, the extension connector plug including an extension plug gasket.

3. A system comprising:
a connecting assembly including:
a connector body, which is generally cylindrical about a central axis,
a collar, which is generally cylindrical about the central axis, positioned around the connector body, and includes a rotation portion, having a first radius, and an engagement portion, the engagement portion having a first edge, a second radius, and a plurality of flanges disposed around the first edge, the flanges protruding away from the central axis, wherein the collar is configured to at least partially rotate around the connector body, and the first radius is greater than the second radius,
a seal coupled to the connector body having a radius larger than the second radius, and
a connector plug, coupled to the seal and including wiring which extends through an opening of the seal, the collar, and the connector body;
a receiving assembly including:
an input device receptacle, which is generally cylindrical about the central axis, having a second edge, and has a plurality of retention flanges disposed around the second edge, the retention flanges protruding toward the central axis, wherein the input device receptacle is configured to receive the connector plug, seal, and engagement portion,
a gasket at least partially disposed over the input device receptacle and configured to abut the seal, and
a receiving receptacle positioned within the input configured to receive the connector plug, wherein the receiving assembly is configured such that in response to a rotation of the collar, the retention flanges interlock with the flanges of the collar and the engagement portion is cinched into the input device receptacle to form a waterproof connection between the connecting assembly and the receiving assembly.
